(19) United States
(12) Patent Application Publication
(10) Pub. No.: US 2023/0229167 A1
(43) Pub. Date: Jul. 20, 2023

(54) AUTONOMOUS TRAVELING CONTROL METHOD FOR CRAWLER VEHICLE, CONTROLLER OF CRAWLER VEHICLE AND CRAWLER VEHICLE

(71) Applicant: CATERPILLAR SARL, Geneva (CH)

(72) Inventors: Hiroaki ANDOU, Akashi-shi (JP); Takahiro SADAMOTO, Akashi-shi (JP)

(73) Assignee: Caterpillar SARL, Geneva (CH)

(21) Appl. No.: 18/011,760

(22) PCT Filed: Jun. 25, 2021
(86) PCT No.: PCT/EP2021/025237

§ 371 Date: Dec. 20, 2022

(30) Foreign Application Priority Data
Jul. 3, 2020 (JP) 2020-115495

(51) Int. Cl. G05D 1/02; E02F 9/20; G05D 1/00

(52) U.S. Cl. CPC G05D 1/0212; E02F 9/2045; G05D 1/0088; G05D 2201/0202

(57) ABSTRACT

To provide an autonomous traveling control method for a crawler vehicle capable of accurately computing a predicted slide-down amount of a crawler vehicle when the crawler vehicle travels on a slope, and enabling an autonomous traveling control based on the predicted slide-down amount. An autonomous traveling control method for a crawler vehicle includes the steps of setting a target trajectory of a crawler vehicle; and computing a predicted slide-down amount of the crawler vehicle when the crawler vehicle travels on a slope on the basis of a target trajectory, using a center of gravity position of the crawler vehicle, an angle of the slope and a traveling direction of the crawler vehicle in the slope.

### FIELD OF THE INVENTION

The present invention relates to an autonomous traveling control method for a crawler vehicle, a controller of a crawler vehicle and a crawler vehicle.

### BACKGROUND OF THE INVENTION

Technology for controlling an autonomous traveling of a crawler vehicle has been developed. As such a control technology, there is known a technique for measuring the coordinates of the crawler vehicle when the crawler vehicle is autonomously traveling, and correcting a traveling direction of the crawler vehicle so that a deviation between measured coordinates of the crawler vehicle and coordinates in a target trajectory becomes zero (see, for example, Patent Literature 1).

### PRIOR ART DOCUMENT

### Patent Document

PATENT DOCUMENT 1: Japanese Patent Application Laid-Open No. H5-297942

### SUMMARY OF THE INVENTION

### Problems to be Solved by the Invention

Generally, at a construction worksite on non-leveled ground where crawler vehicle such as hydraulic shovel or bulldozer is used, when the crawler vehicle travels on a slope (especially a slope of soft ground), slippage may occur between the crawler and the soil, and the crawler vehicle may slide down. However, in an autonomous traveling control technology of the crawler vehicle, slippage between the crawler and the soil is not assumed, and when the crawler vehicle travels on the slope on the basis of the target trajectory, there is a danger of sliding down and overturning of the crawler vehicle. In addition, if the slide-down of the crawler vehicle is not taken into account, there is a problem that the actual trajectory of the crawler vehicle runs off the target trajectory even if the traveling direction of the crawler vehicle is corrected.

The present invention was made in view of the facts described above, the object is to provide an autonomous traveling control method for a crawler vehicle in which a predicted slide-down amount of the crawler vehicle when the crawler vehicle travels on a slope can be accurately computed, and an autonomous traveling control based on the predicted slide-down amount becomes possible, a controller of a crawler vehicle, and a crawler vehicle.

### Means for Solving the Problem

The first aspect of the present invention is to provide an autonomous traveling control method for a crawler vehicle as described below in order to solve the above problems. That is, the first aspect of the present invention is to provide an autonomous traveling control method for a crawler vehicle including the steps of setting a target trajectory of a crawler vehicle; and computing a predicted slide-down amount of the crawler vehicle when the crawler vehicle travels on a slope on the basis of the target trajectory, using a center of gravity position of the crawler vehicle, an angle of the slope and a traveling direction of the crawler vehicle in the slope.

The autonomous traveling control method for the crawler vehicle of the present invention preferably includes a step of determining whether or not the crawler vehicle is allowed to travel on the slope on the basis of the target trajectory, using the predicted slide-down amount. The autonomous traveling control method for the crawler vehicle of the present invention may include a step of computing a correction amount of the traveling direction for causing the crawler vehicle to travel along the target trajectory, using the predicted slide-down amount. The crawler vehicle comprises a lower traveling structure, an upper revolving structure supported by the lower traveling structure so as to be freely revolvable, and a working arm device mounted on the upper revolving structure so as to be freely swingable, wherein in the step of computing the predicted slide-down amount, the center of gravity positions at a plurality of time steps are preferably computed using a revolving angle of the upper revolving structure with respect to the lower traveling structure, and a swinging angle of the working arm device with respect to the upper revolving structure.

The second aspect of the present invention is to provide a controller of a crawler vehicle below in order to solve the above problems. That is, the second aspect of the present invention is to provide a controller of a crawler vehicle including a setting means for setting a target trajectory of a crawler vehicle; and a predicted slide-down amount computation means for computing a predicted slide-down amount of the crawler vehicle when the crawler vehicle travels on a slope on the basis of the target trajectory, using a center of gravity position of the crawler vehicle, an angle of the slope and a traveling direction of the crawler vehicle in the slope.

The controller of the crawler vehicle of the present invention favorably includes a determination means for determining whether or not the crawler vehicle is allowed to travel on the slope on the basis of the target trajectory, using the predicted slide-down amount. The controller of the crawler vehicle of the present invention may include a correction amount computation means for computing a correction amount of the traveling direction for causing the crawler vehicle to travel along the target trajectory, using the predicted slide-down amount. The crawler vehicle comprises a lower traveling structure, an upper revolving structure supported by the lower traveling structure so as to be freely revolvable, and a working arm device mounted on the upper revolving structure so as to be freely swingable, wherein the predicted slide-down amount computation means preferably computes the center of gravity positions at a plurality of time steps, using a revolving angle of the upper revolving structure with respect to the lower traveling structure, and a swinging angle of the working arm device with respect to the upper revolving structure.

The third aspect of the present invention is to provide a crawler vehicle comprising the controller as described above, in order to solve the above problems.

### Favorable Effects of the Invention

According to the present invention, since a target trajectory of a crawler vehicle is set, and a predicted slide-down amount of the crawler vehicle when the crawler vehicle travels on a slope on the basis of the target trajectory is computed using a center of gravity position of the crawler vehicle, an angle of the slope, and a traveling direction of the crawler vehicle in the slope, a predicted slide-down amount of the crawler vehicle when the crawler vehicle travels on the slope can be accurately computed, and thereby an autonomous traveling control based on the predicted slide-down amount of the crawler vehicle becomes possible.

### BRIEF DESCRIPTION OF THE DRAWINGS

FIG. 1 is a side view of a crawler vehicle configured in accordance with the present invention.

FIG. 2 is a block diagram illustrating a configuration of a first form of a controller mounted on the crawler vehicle illustrated in FIG. 1.

FIG. 3 is a flowchart of an autonomous traveling control method implemented in the crawler vehicle illustrated in FIG. 1.

FIG. 4 is a flowchart illustrating details of Step S2 illustrated in FIG. 3.

FIG. 5 is a schematic view illustrating a state in which the crawler vehicle illustrated in FIG. 1 is located on a slope.

FIG. 6 is a schematic view of the crawler vehicle as viewed from a VI-VI direction in FIG. 5.

FIG. 7 is a schematic view of a crawler as viewed from a VII-VII direction in FIG. 5.

FIG. 8 is a schematic view illustrating forces acting on the crawler vehicle when the crawler vehicle illustrated in FIG. 1 is traveling on the slope.

FIG. 9 is a schematic view illustrating a time history target trajectory that is set in Step S1 illustrated in FIG. 3 and a time history predicted trajectory computed in Step S2 illustrated in FIG. 3.

FIG. 10 is a block diagram illustrating a configuration of a second form of the controller configured in accordance with the present invention.

FIG. 11 is a flowchart of an traveling control method implemented in the crawler vehicle provided with the controller illustrated in FIG. 10.

FIG. 12 is a block diagram illustrating a configuration of a third form of the controller configured in accordance with the present invention.

FIG. 13 is a flowchart of an traveling control method implemented in the crawler vehicle provided with the controller illustrated in FIG. 12.

### DETAILED DESCRIPTION OF THE INVENTION

Hereinbelow, preferred embodiments of an autonomous traveling control method for a crawler vehicle, a controller of a crawler vehicle, and a crawler vehicle of the present invention will be described while referring to the drawings.

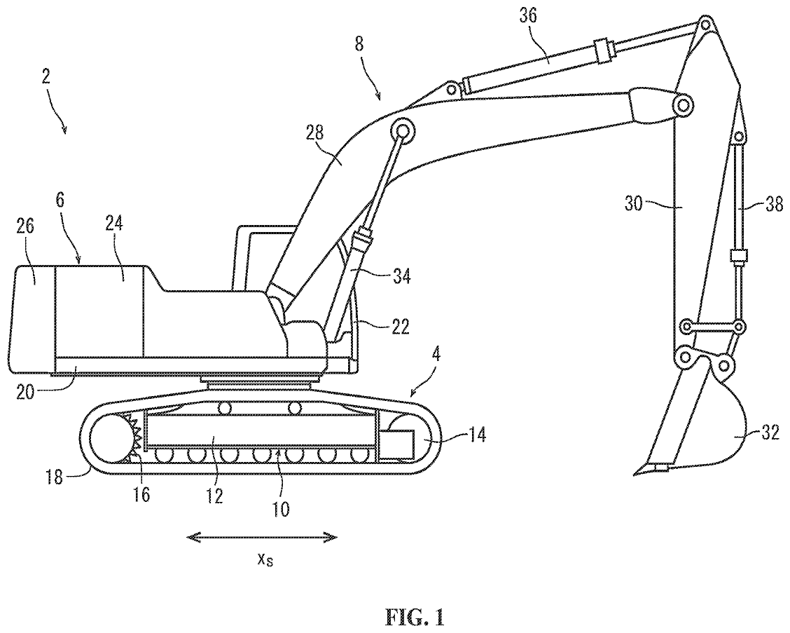

FIG. 1 illustrates a hydraulic shovel 2 as an example of the crawler vehicle configured in accordance with the present invention. The hydraulic shovel 2 comprises a lower traveling structure 4, an upper revolving structure 6 supported by the lower traveling structure 4 so as to be freely revolvable, and a working arm device 8 mounted on the upper revolving structure 6 so as to be freely swingable.

The lower traveling structure 4 includes a base frame 10, and the base frame 10 has a pair of left and right track frames 12 (only one side is illustrated) extending in a front-rear direction at both end portions in the widthwise direction. An idler 14 is supported so as to be freely rotatable on one side end portion of each track frame 12 in the front-rear direction, and a sprocket 16 as a drive wheel is supported so as to be freely rotatable on the other side end portion of each track frame 12 in the front-rear direction. A crawler 18 is mounted so as to be freely rotatable to each track frame 12, and the crawler 18 is wound around the idler 14 and the sprocket 16. Then, the hydraulic shovel 2 is capable of self-traveling in the direction indicated by an arrow xs in FIG. 1, by rotating the crawler 18 via the sprocket 16. Said widthwise direction is orthogonal to the xs direction and perpendicular to the paper surface in FIG. 1.

The upper revolving structure 6 include a revolving frame 20, a cab 22 in which driver's seat for an operator and operation units, a monitor etc. are arranged, an equipment accommodating chamber 24 in which equipment such as an engine and a hydraulic pump are accommodated, and a counterweight 26 for attaining a balance against the working arm device 8.

The working arm device 8 includes a boom 28, an arm 30, and a working implement 32. The base end portion of the boom 28 is connected to the revolving frame 20 so as to be freely swingable, the base end portion of the arm 30 is connected to the distal end portion of the boom 28 so as to be freely swingable, and the working implement 32 is connected to distal end portion of the arm 30 so as to be freely swingable. Further, the working arm device 8 includes a boom cylinder 34 that causes the boom 28 to be swung, an arm cylinder 36 that causes the arm 30 to be swung, and a working implement cylinder 38 that causes the working implement 32 to be swung. Then, in the hydraulic shovel 2, various works such as excavation work are performed by causing each of the boom 28, the arm 30, and the working implement 32 to be swung (changing a posture of the working arm device 8).

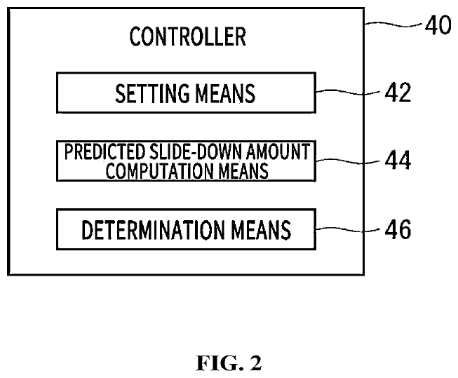

To explain with reference to FIG. 2, the hydraulic shovel 2 comprises a controller 40 that controls the autonomous traveling of the hydraulic shovel 2. The controller 40 may be constituted of a computer having a processing device and a storage device. It is important that the controller 40 includes a setting means 42 for setting a target trajectory of the hydraulic shovel 2 and a predicted slide-down amount computation means 44 for computing a predicted slide-down amount of the hydraulic shovel 2 when the hydraulic shovel 2 travels on the slope on the basis of the target trajectory, using a center of gravity position of the hydraulic shovel 2, an angle of the slope and a traveling direction of the hydraulic shovel 2 in the slope. The controller 40 of the present embodiment further includes a determination means 46 for determining whether or not the hydraulic shovel 2 is allowed to travel on the slope on the basis of the target trajectory, using the predicted slide-down amount.

Various changeable data is stored in the controller 40. For example, data of the hydraulic shovel 2 and data of the site, where the hydraulic shovel 2 is used, is stored in advance. The data of the hydraulic shovel 2 stored in the controller 40 includes a total weight of the hydraulic shovel 2; respective weights and respective center of gravity positions of the lower traveling structure 4, the upper revolving structure 6, the boom 28, the arm 30 and the working implement 32; the width and length of the crawler 18; and the radii of the idler 14 and the sprocket 16 and the like.

The site data stored in the controller 40 includes three-dimensional map data including fixed obstacles and undulations at the site where the hydraulic shovel 2 is used, and data regarding the soil at the site where the hydraulic shovel 2 is used (including values used as soil parameters when the predicted slide-down amount is computed). The soil parameters include, for example, sinkage index, cohesive power of soil, internal friction angle of soil etc., and a table of the soil parameters corresponding to various conditions can be stored in the controller 40.

Various types of equipment (not illustrated) mounted on the hydraulic shovel 2 are electrically connected to the controller 40, and information detected by the various types of equipment is input to the controller 40. Equipment connected to the controller 40 include, for example, a GPS receiver for detecting the position of the hydraulic shovel 2; an inertial measurement unit (IMU) for detecting the speed and acceleration of the hydraulic shovel 2; a revolving angle sensor that detects a revolving angle of the upper revolving structure 6 with respect to and the lower traveling structure 4; a boom angle sensor that detects a swinging angle of the boom 28 with respect to the upper revolving structure 6; an arm angle sensor that detects a swinging angle of the arm 30 with respect to the boom 28; a working implement angle sensor that detects a swinging angle of the working implement 32 with respect to the arm 30; and cameras and LiDAR (Light Detection and Ranging) for detecting moving obstacles that move on the site and fixed obstacles that are fixed on the site.

Next, the traveling control method implemented in the hydraulic shovel 2 as described above will be described.

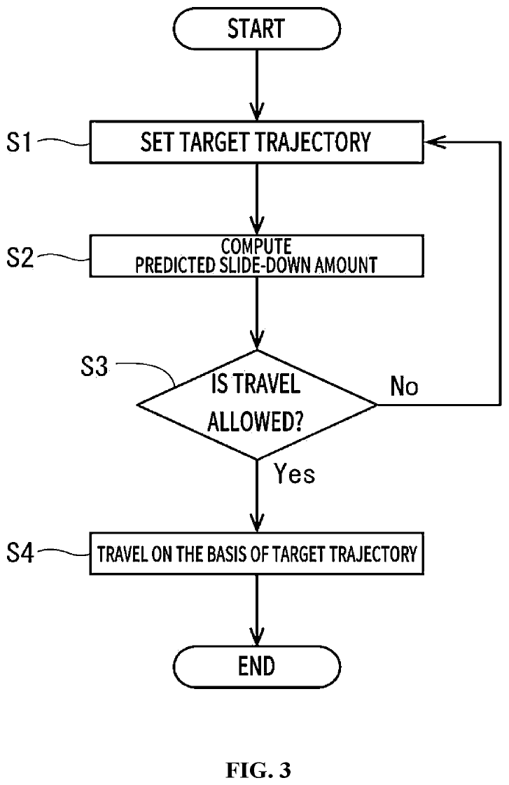

In the present embodiment, as illustrated in FIG. 3, first, Step S1 for setting the target trajectory of the hydraulic shovel 2 is executed. In Step S1, for example, the setting means 42 sets a trajectory that is input to the controller 40 by the operator of the hydraulic shovel 2 as a target trajectory. The target trajectory of the present embodiment is supposed to include a slope. Also, the target trajectory may be composed of a plurality of coordinate points.

In Step S1, the setting means 42 may select and set a target trajectory on the basis of a target spot that is input to the controller 40 by the operator. For example, the setting means 42 may select the shortest route connecting the present spot of the hydraulic shovel 2 and the target spot and set it as the target trajectory. Alternatively, the setting means 42 may set a trajectory that passes through one or more passing spots that are input to the controller 40 by the operator and reaches the target spot as the target trajectory. With regard to the information on the present spot of the hydraulic shovel 2, the information detected by the GPS receiver can be used, or the information obtained by SLAM (Simultaneous Localization and Mapping) technology may be used.

In Step S1, if obstacles exist between the present spot and the target spot of the hydraulic shovel 2, the setting means 42 can also set a trajectory that avoids the obstacles as a target trajectory. With regard to the information on the obstacles, the information on the fixed obstacle that is input to the controller 40 in advance and the information on the obstacles (including the fixed obstacle and the moving obstacle) detected by the cameras or LiDAR can be used.

In Step S1, from the viewpoint of ensuring that the hydraulic shovel 2 travels safely without overturning or deviating significantly from the target trajectory, a condition that the angle of the slope on which the hydraulic shovel 2 travels does not exceed a predetermined angle is preferably included as a constraint condition. With regard to the angle of the slope, the information of the three-dimensional map data pre-stored in the controller 40 can be used.

After executing Step S1, as illustrated in FIG. 3, Step S2 for computing a predicted slide-down amount of the hydraulic shovel 2 when the hydraulic shovel 2 travels on the slope on the basis of the target trajectory, using the center of gravity position of the hydraulic shovel 2, the angle of the slope, and the traveling direction of the hydraulic shovel 2 in the slope is executed by the predicted slide-down amount computation means 44.

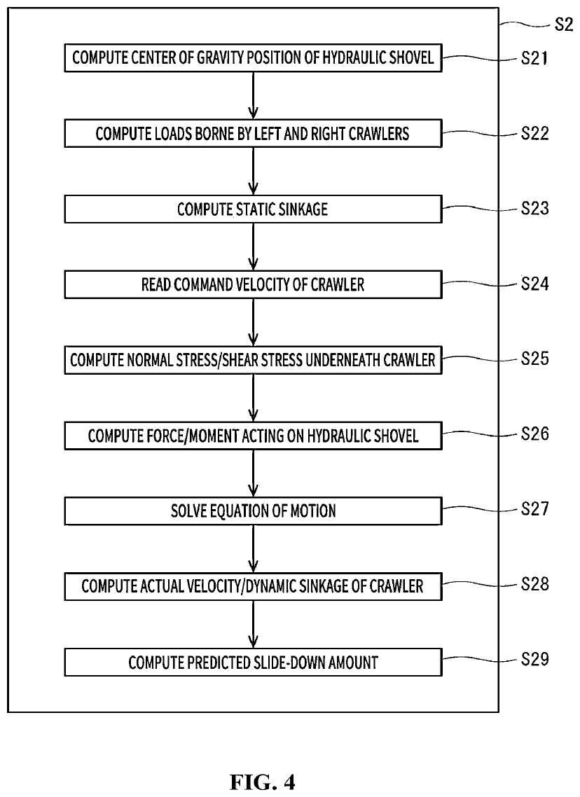

In Step S2 of the present embodiment, by repeatedly executing Steps S21 to S29 illustrated in FIG. 4, predicted slide-down amounts at the plurality of time steps to (n=1, 2, 3, . . . ) when the hydraulic shovel 2 travels on the slope on the basis of the target trajectory are computed.

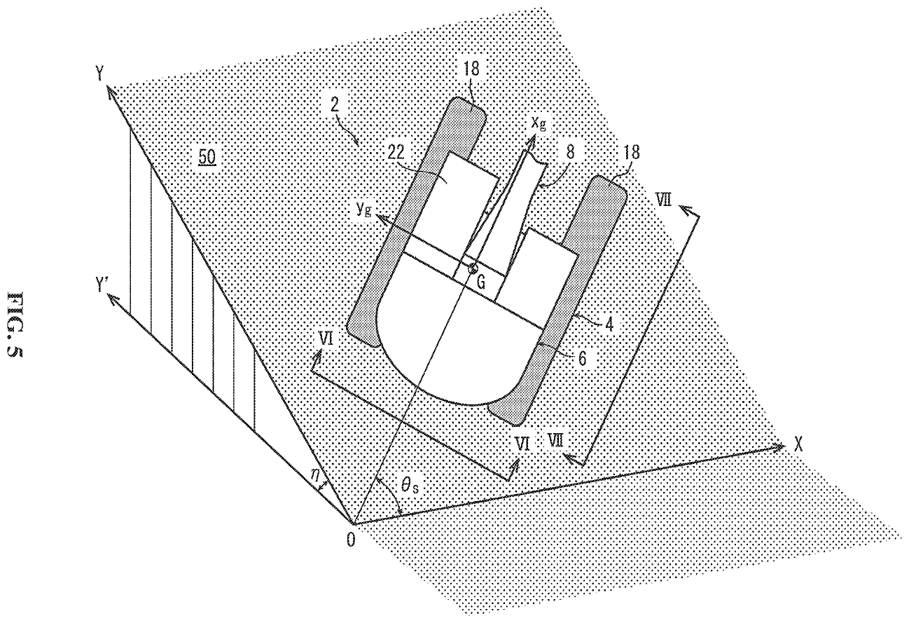

First, in Step S21, the center of gravity G position (see FIG. 5) of the hydraulic shovel 2 is computed by the predicted slide-down amount computation means 44 using the data pre-stored in the controller 40 and the data detected by various types of equipment.

In Step S21, the predicted slide-down amount computation means 44 computes the center of gravity G position of the hydraulic shovel 2 before start of traveling on the basis of the target trajectory, using the total weight of the hydraulic shovel 2; the weight and the center of gravity position of the lower traveling structure 4; the weight, the center of gravity position and the revolving angle of the upper revolving structure 6; the weight, the center of gravity position and the swinging angle of the boom 28; the weight, the center of gravity position and the swinging angle of the arm 30; and the weight, the center of gravity position and the swinging angle of the working implement 32.

In Step S2 of the present embodiment, when Steps S21 to S29 are repeatedly executed, the center of gravity G positions at the plurality of time steps are computed using the revolving angle of the upper revolving structure 6 with respect to the lower traveling structure 4, and the swinging angle of the working arm device 8 with respect to the upper revolving structure 6 (in the illustrated embodiment, respective swinging angles of the boom 28, the arm 30 and the working implement 32). This allows the predicted slide-down amount to be accurately computed even in cases where the center of gravity G position changes due to revolving of the upper revolving structure 6 or swinging of the working arm device 8 while the hydraulic shovel 2 is traveling. Therefore, when the predicted slide-down amount is computed in step 2, it may be assumed that each of the revolving angle of the upper revolving structure 6 and the swinging angle of the working arm device 8 is to be kept constant while the hydraulic shovel 2 is traveling, or may be assumed that the revolving angle of the upper revolving structure 6 or the swinging angle of the working arm device 8 changes while the hydraulic shovel 2 is traveling.

After computing the center of gravity G position of the hydraulic shovel 2, the loads which the left and right crawlers 18 bear in order to support the hydraulic shovel 2 (hereinafter, sometimes referred to as “left crawler load” and “right crawler load” respectively) are computed (see Step S22, FIG. 4).

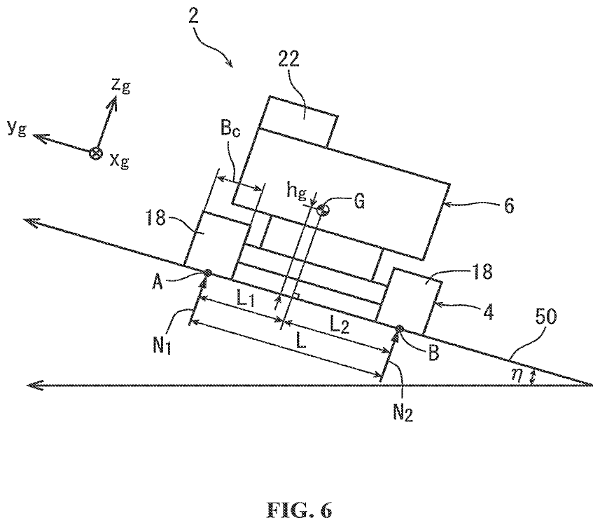

The computation of the crawler loads will be described with reference to FIGS. 5 and 6. FIG. 5 is a schematic view illustrating a state in which the hydraulic shovel 2 is located on the slope 50 with an angle η. The XY coordinate in FIG. 5 is a reference coordinate system that is fixed on the slope 50, and the XY′ coordinate is a global coordinate system. The X-axis is a horizontal axis common to the reference coordinate system and the global coordinate system, and the Y-axis is an axis orthogonal to the X-axis, having a positive direction in an upward direction of the slope 50. The xgyg coordinate is a vehicle center of gravity coordinate (local coordinate system) that is fixed in the hydraulic shovel 2, having the origin at the center of gravity G of the hydraulic shovel 2 on the reference coordinate system (slope). The xg-axis is an axis indicating the traveling direction of the hydraulic shovel 2, having the origin at the center of gravity G of the hydraulic shovel 2 on the reference coordinate system (slope). The yg-axis is an axis orthogonal to the traveling direction of the hydraulic shovel 2, having the origin at the center of gravity G of the hydraulic shovel 2 on the reference coordinate system (slope). The angle θs is an angle formed between the X-axis of the reference coordinate system and the xg-axis of the vehicle center of gravity coordinate system (hereinafter referred to as “vehicle direction angle θs”), and is an angle indicating the traveling direction of the hydraulic shovel 2. While FIG. 5 illustrates the slope 50 of which angle η is constant for convenience' sake, the angle may not be constant in the slope in the target trajectory.

FIG. 6 illustrates a schematic view of the hydraulic shovel 2 as viewed from the VI-VI direction in FIG. 5. To explain the reference numerals illustrated in FIG. 6, L1 denotes a distance in the yg-axis direction between the center of gravity G of the hydraulic shovel 2, which is the origin of the vehicle center of gravity coordinate system, and the lateral direction (yg-axis direction) center of the left crawler 18 in FIG. 6. The distance L2 is a distance in the yg-axis direction between the center of gravity G of the hydraulic shovel 2 and the lateral direction center of the right crawler 18 in FIG. 6. L is a distance (L=L1+L2) in the yg-axis direction from the lateral direction center of the left crawler 18 to the lateral direction center of the right crawler 18. The zg-axis is an axis perpendicular to each of the xg-axis and the yg-axis, and hg is a distance in the zg-axis direction from the center of gravity G of the hydraulic shovel 2 to the slope 50.

Assuming that a bearing capacity N1 in the zg-axis direction acts on the left crawler 18 at a A-point (a point on the center line passing through the lateral direction center of the left crawler 18) illustrated in FIG. 6, and a bearing capacity N2 in the zg-axis direction acts on the right crawler 18 at a B-point (a point on the center line passing through the lateral direction center of the right crawler 18) illustrated in FIG. 6, the balance of the forces in the zg-axis direction is expressed as Equation (1) using the angle η of the slope 50. Further, the balance of moment around the B-point is expressed as Equation (2) using the angle η of the slope 50 and the vehicle direction angle θs, where W is the total weight of the hydraulic shovel 2, and G is the gravitational acceleration.

[Mathematical 1]

N₁+N₂=Wg cos η (1)

[Mathematical 2]

LN₁=Wg(L₂ cos η−h_{g} cos θₐ sin η) (2)

From Equations (1) and (2), the bearing capacities N1, N2 are expressed as Equations (3) and (4).

$$\begin{matrix}[ Mathematical 3 ] & \\ {N}_{1} = \frac{Wg}{L} ( {L}_{2} cos η - {h}_{g} cos {θ}_{g} sin η ) & ( 3 )\end{matrix}$$

$$\begin{matrix}[ Mathematical 4 ] & \\ {N}_{2} = \frac{Wg}{L} \{ ( L - {L}_{2} ) cos η + {h}_{g} cos {θ}_{g} sin η \} & ( 4 )\end{matrix}$$

The magnitude of the load (left crawler load) W1 borne by the left crawler 18 is equal to the magnitude of the bearing capacity N1 (W1=N1), and the magnitude of the load (right crawler load) W2 borne by the right crawler 18 is equal to the magnitude of the bearing capacity N2 (W2=N2). In this manner, in Step S22, the left and right crawler loads W1 and W2 are computed using the is center of gravity G position of the hydraulic shovel 2, the angle 11 of the slope 50, and the traveling direction (vehicle direction angle θs) of the hydraulic shovel 2 in the slope 50.

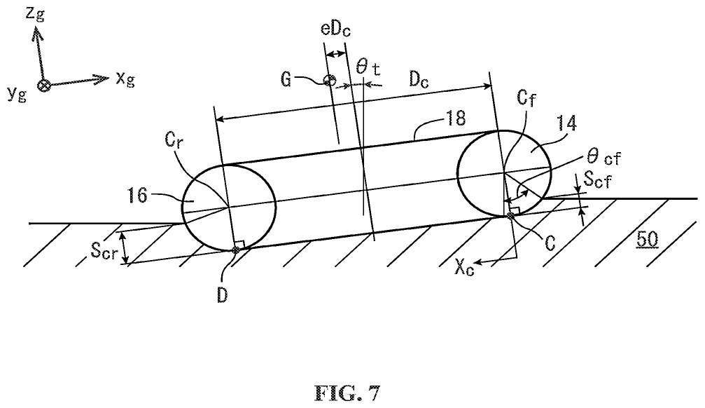

After computing the left and right crawler loads W1 and W2, static sinkage of the crawlers 18 underneath the left and right idlers 14 and static sinkage of the crawlers 18 underneath the left and right sprockets 16 are computed (see Step S23 in FIG. 4). To explain with reference to FIG. 7, when the hydraulic shovel 2 rests on the slope 50, a pitch angle θt is formed between the slope 50 and the crawler 18 depending on an eccentricity e of the center of gravity G of the hydraulic shovel 2. The pitch angle θt is expressed as Equation (5) using the static sinkage Scf (the static sinkage of the crawler 18 at a C-point) underneath the idler 14, the static sinkage Scr (the static sinkage of the crawler 18 at a D-point) underneath the sprocket 16, and the length Dc of the crawler 18 (the distance in the xg-axis direction connecting the center Cf of the idler 14 and the center Cr of the sprocket 16).

$$\begin{matrix}[ Mathematical 5 ] & \\ {θ}_{t} = {tan}^{- 1} ( \frac{{S}_{cr} - {S}_{cf}}{{D}_{c}} ) & ( 5 )\end{matrix}$$

The C-point in FIG. 7 is an intersection of a perpendicular line dropped in the zg-axis direction from the center Cf of the idler 14 to the crawler 18 and the crawler 18, and the D-point is an intersection of a perpendicular line dropped in the zg-axis direction from the center Cr of the sprocket 16 to the crawler 18 and the crawler 18.

The static sinkage distribution Sc (Xc) of the crawler 18 is expressed as Equation (6), and the normal stress distribution pc (Xc) underneath the crawler 18 related to the static sinkage distribution Sc (Xc) is expressed as Equation (7).

$$\begin{matrix}[ Mathematical 6 ] & \\ {S}_{c} ( {X}_{c} ) = {S}_{cf} + ( {S}_{cr} - {S}_{cf} ) \frac{{X}_{c}}{{D}_{c}} & ( 6 )\end{matrix}$$

[Mathematical 7]

p_{c}(X_{c})=k{S_{c}(X_{c})}ⁿ (7)

Xc in Equations (6) and (7) is a local coordinate system extending in the longitudinal direction of the crawler 18 with the C-point as the origin. “k” and “n” in Equation (7) are soil parameters.

The balance of forces in a direction vertical to the crawler 18 (in the zg-axis direction) is expressed as Equation (8), and the balance of moments around the C-point is expressed as Equation (9), wherein Bc is the width of the crawler 18 (see FIG. 6).

$$\begin{matrix}[ Mathematical 8 ] & \\ \begin{matrix}{W}_{c} cos {θ}_{t} = {B}_{c} {\int }_{0}^{{D}_{c}} {p}_{c} ( {X}_{c} ) {dX}_{c} \\ = {B}_{c} {\int }_{0}^{{D}_{c}} l {\{ {S}_{cf} + ( {S}_{cr} - {S}_{cf} ) \frac{{X}_{c}}{{D}_{c}} \}}^{n} {dX}_{c} \\ = \frac{{B}_{c} {kD}_{c}}{n + 1} \cdot \frac{{S}_{cr}^{n + 1} - {S}_{cf}^{n + 1}}{{S}_{cr} - {S}_{cf}}\end{matrix} & ( 8 )\end{matrix}$$

$$\begin{matrix}[ Mathematical 9 ] & \\ \begin{matrix}{W}_{c} cos {θ}_{t} \cdot ( \frac{1}{2} + e ) {D}_{c} = {B}_{c} {\int }_{0}^{{D}_{c}} {p}_{c} ( {X}_{c} ) {X}_{c} {dX}_{c} \\ = {B}_{c} k {\int }_{0}^{{D}_{c}} {X}_{s} {\{ {S}_{cf} + ( {S}_{cr} - {S}_{cf} ) \frac{{X}_{c}}{{D}_{c}} \}}^{n} {dX}_{c} \\ = \frac{{B}_{c} {kD}_{c}^{2}}{( n + 1 ) ( {S}_{cr} - {S}_{cf} )} \{ {S}_{cr}^{n + 1} - \frac{{S}_{cr}^{n + 2} - {S}_{cf}^{n + 2}}{( n + 2 ) ( {S}_{cr} - {S}_{cf} )} \}\end{matrix} & ( 9 )\end{matrix}$$

Wc in each of Equations (8) and (9) is a crawler load. The static sinkage Scf underneath the left idler 14 and the static sinkage Scr underneath the left sprocket 16 can be computed, by substituting the left crawler load W1 (the right side of Equation (3)) into the Wc in Equations (8) and (9) to solve Equations (8) and (9). Also, the static sinkage Scf underneath the right idler 14 and the static sinkage Scr underneath the right sprocket 16 can be computed, by substituting the right crawler load W2 (the right side of Equation (4)) into the Wc in Equations (8) and (9) to solve Equations (8) and (9).

In Step S23 in this manner, the static sinkages Scf underneath the left and right idlers 14 and the static sinkages Scr underneath the left and right sprockets 16 are computed, by substituting the left and right crawler loads W1 and W2 computed using the center of gravity G position of the hydraulic shovel 2, the angle η of the slope 50 and the traveling direction of the hydraulic shovel 2 (vehicle direction angle θs) in the slope 50, into Equations (8) and (9).

After computing the static sinkages Scf and Scr of the crawler 18, command velocities (command movement velocities) of the left and right crawlers 18 are read (Step S24, see FIG. 4). The command velocities of the left and right crawlers 18 to be read in Step S24 can be set at any time if earlier than Step S24, and the command velocities of the crawlers 18 can be set before the computation of the center of gravity G position of the hydraulic shovel 2, the computation of the crawler loads W1 and W2, or the computation of the static sinkages Scf and Scr, alternatively in parallel with the computation of the center of gravity G position and the like. The command velocities of the crawlers 18 at respective time steps may be constant values or different values. The command velocities of the crawlers 18 may be set by the operator by inputting appropriate command velocities to the controller 40.

After reading the command velocities of the left and right crawlers 18, the normal stress distribution and the shear stress distribution underneath the left and right crawlers 18 are computed (Step S25). The normal stress distribution pc (Xc) acting underneath the left and right crawlers 18 is expressed as Equation 10 using the total sinkage distribution Ss (Xc) of the crawler 18 which takes the static sinkages Scf and Scr and the dynamic sinkages Sscf and Sscr into consideration.

[Mathematical 10]

p_{c}(X_{c})=k{S_{g}(X_{c})}ⁿ (10)

The total sinkage distribution Ss (Xc) of the crawler 18 is expressed as Equation (11) using the total sinkage Sf (Sf=Scf+Sscf) underneath the idler 14 represented by the sum of the static sinkage Scf underneath the idler 14 and the dynamic sinkage Sscf underneath the idler 14, and the total sinkage Sr (Sr=Scr+Sscr) underneath the sprocket 16 represented by the sum of the static sinkage Scr underneath the sprocket 16 and the dynamic sinkage Sscr underneath the sprocket 16.

$$\begin{matrix}[ Mathematical 11 ] & \\ {S}_{a} ( {X}_{c} ) = {S}_{f} + ( {S}_{r} - {S}_{f} ) \frac{{X}_{c}}{{D}_{c}} & ( 11 )\end{matrix}$$

Regarding the dynamic sinkages Sscf and Sscr, when computing in Step S28 described below, the total sinkage Sf underneath the idler 14 at the time step tn can be computed as the sum of the static sinkage Scf underneath the idler 14 at the time step tn and the dynamic sinkage Sscf underneath the idler 14 at the time step tn−1. Regarding the total sinkage Sr underneath the sprocket 16 as well, the same will apply. When computing the total sinkages Sf and Sr at the first time step t1, arbitrary values that are input in advance to the controller 40 can be used as initial values of the dynamic sinkages Sscf and Sscr.

To explain the shear stress distribution underneath the crawler 18, the shear stress distribution τc (Xc) acting in the xg-axis direction (traveling direction) underneath the crawler 18 during driving can be computed using Equation (12); the shear stress distribution τc (Xc) acting in the xg-axis direction underneath the crawler 18 during braking can be computed using Equation (13); and the shear stress distribution τcy (Xc) acting in the yg-axis direction underneath the crawler 18 can be computed by Equation (14).

$$\begin{matrix}[ Mathematical 12 ] & \\ {τ}_{c} ( {X}_{c} ) = ( c + {p}_{c} ( {X}_{c} ) tan ϕ \{ 1 - exp ( - \frac{{j}_{c} ( {X}_{c} )}{{k}_{a}} ) \} & ( 12 )\end{matrix}$$

$$\begin{matrix}[ Mathematical 13 ] & \\ {τ}_{c} ( {X}_{c} ) = - ( c + {p}_{c} ( {X}_{c} ) tan ϕ \{ 1 - exp ( \frac{{j}_{c} ( {X}_{c} )}{{k}_{a}} ) \} & ( 13 )\end{matrix}$$

$$\begin{matrix}[ Mathematical 14 ] & \\ {τ}_{cy} ( {X}_{c} ) = ( {c}_{a} + {p}_{c} ( {X}_{c} ) tan {ϕ}_{a} \{ 1 - exp ( - \frac{{j}_{cy} ( {X}_{c} )}{{k}_{a}} ) \} & ( 14 )\end{matrix}$$

Parameters c, ca, φ, φa, and ka in Equations (12) to (14) are all soil parameters. Further, jc (Xc) in Equations (12) and (13) is a slip amount distribution in the traveling direction (xg-axis direction) of the crawler 18; and jcy (Xc) in Equation (14) is a slip amount distribution in the yg-axis direction of the crawler 18. Both jc (Xc) and jcy (Xc) can be computed using a slip ratio id represented by the command velocity of the crawler 18 and the actual velocity of the crawler 18.

The actual velocity of the crawlers 18 is a moving velocity of the crawler 18 which is predicted when the hydraulic shovel 2 actually travels, and is computed in Step S28 as described below. When computing the shear stress distributions τc (Xc) and icy (Xc) at the time step tn, the slip ratio id computed using the actual velocity of the crawler 18 at the time step tn−1 can be used. When computing the shear stress distributions τc (Xc) and τcy (Xc) at the first time step t1, arbitrary values which are input to the controller 40 can be used as the initial value of the actual velocity of the crawler 18.

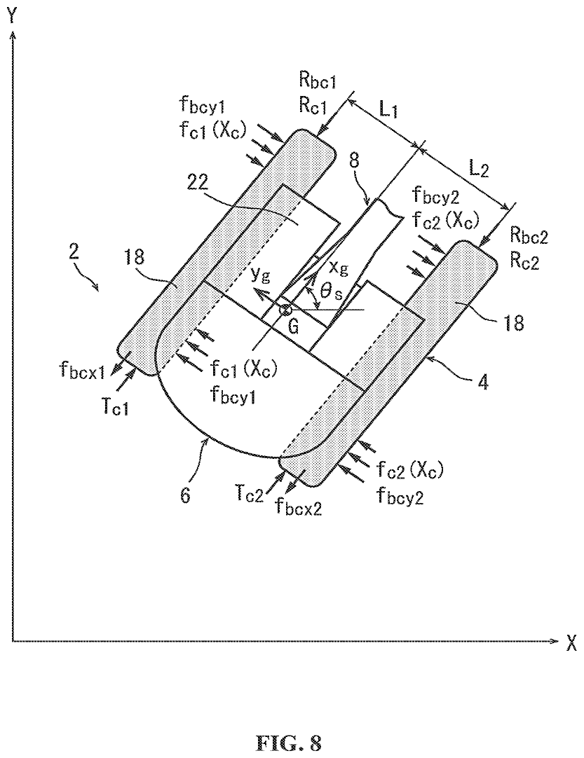

After computing the normal stress distribution pc (Xc) and the shear stress distributions τc (Xc) and τcy (Xc) underneath the left and right crawlers 18, forces and moments acting on the hydraulic shovel 2 are computed (Step S26). To explain with reference to FIG. 8, in Step S26 of the present embodiment, the followings are computed: driving forces Tc1 and Tc2 of the left and right crawlers 18; compaction resistance forces Rc1 and Rc2 caused by compacting the soil by the crawlers 18 when the hydraulic shovel 2 travels; earth removing resistance forces Rbc1 and Rbc2 generated by the crawlers 18 pushing away the soil when the hydraulic shovel 2 travels; lateral shear resistance forces fc1 and fc2 generated by the soil underneath the crawlers 18 being sheared in the lateral direction (yg-axis direction); earth removing resistance forces fbcx1, fbcy1, fbcx2, fbcy2 in the xg-axis direction and yg-axis direction generated by the soil being pushed away when the crawlers 18 sideslip; moments Mc1 and Mc2 (not illustrated) generated in the hydraulic shovel 2 by the lateral shear resistance forces fc1 and fc2; and moments Mbc1 and Mbc2 (not illustrated) generated in the hydraulic shovel 2 by the earth removing resistance forces fbcy1 and fbcy2.

The forces and moments to be computed in Step S26 can be computed using known mathematical formulas in the theory of terramechanics. The subscript 1 appended to the driving forces Tc1 and Tc2 and the compaction resistance forces Rc1 and Rc2 and the like indicates forces and moments related to the left crawler 18, and the subscript 2 indicates forces and moments related to the right crawler 18.

After computing the forces and moments acting on the hydraulic shovel 2, accelerations of the center of gravity G (d2xg/dt2, d2yg/dt2), velocities of the center of gravity G (dxg/dt, dyg/dt), coordinates of the center of gravity G (xg, yg), an angular acceleration around the center of gravity G (d2θs/dt2), an angular velocity around the center of gravity G (dθs/dt) and a vehicle direction angle θs are computed in the reference coordinate system (XY coordinate system) fixed to the slope 50, by solving Equations (15) to (17) which are equations of motion related to the center of gravity G of the hydraulic shovel 2 (Step S27). Equation (15) is an equation of motion in the xg-axis, Equation (16) is an equation of motion in the yg-axis, and Equation (17) is an equation of motion of rotation around the axis line in the zg-axis direction passing through the center of gravity G.

$$\begin{matrix}[ Mathematical 15 ] & \\ W ( \frac{{d}^{2} {x}_{g}}{{dt}^{2}} - \frac{{dy}_{g}}{dt} \frac{d {θ}_{s}}{dt} + g sin {θ}_{s} sin η ) = {\sum }_{i = 1}^{2} ( {T}_{ci} + {R}_{ci} + {R}_{bci} + {f}_{bcxi} ) & ( 15 )\end{matrix}$$

$$\begin{matrix}[ Mathematical 16 ] & \\ W ( \frac{{d}^{2} {y}_{g}}{{dt}^{2}} + \frac{{dx}_{g}}{dt} \frac{d {θ}_{s}}{dt} + g cos {θ}_{s} sin η ) = {\sum }_{i = 1}^{2} ( {f}_{ci} + {f}_{bcyi} ) & ( 16 )\end{matrix}$$

$$\begin{matrix}[ Mathematical 17 ] & \\ I \frac{{d}^{2} {θ}_{s}}{{dt}^{2}} = {\sum }_{i = 1}^{2} ( {M}_{ci} + {M}_{bci} ) + {L}_{1} ( {T}_{c 1} + {R}_{c 1} + {R}_{bc 1} + {f}_{bcx 1} ) - {L}_{2} ( {T}_{c 2} + {R}_{c 2} + {R}_{bc 2} + {f}_{bcx 2} ) & ( 17 )\end{matrix}$$

W in the Equations (15) and (16) is a total weight of the hydraulic shovel 2, and I in Equation (17) is a moment of inertia around the center of gravity G. The vehicle direction angle θs at the time step tn computed in Step S27 is used when computing the crawler loads W1 and W2 at the time step tn+1 in the next Step S22.

After solving the equations of motion related to the center of gravity G of the hydraulic shovel 2, the actual velocity and the dynamic sinkage of each crawler 18 are computed (Step S28). The actual velocity of each crawler 18 can be computed using the velocities (dxg/dt, dyg/dt) the center of gravity G and the angular velocity (θs/dt) around the center of gravity G obtained in Step S27, as well as a distance from the center of gravity G to the central point (the center in the xg-axis direction and the center in the yg-axis direction of the crawler 18) of each crawler 18. The actual velocity of each crawler 18 at the time step tn computed in Step S28 is used when computing the shear stress distributions τc (Xc) and icy (Xc) at the time step tn+1 in Step S25.

According to the theory of terramechanics, the dynamic sinkage Sscf underneath the idler 14 can be computed using Equation (18), and the dynamic sinkage Sscr underneath the sprocket 16 can be computed using Equation (19).

$$\begin{matrix}[ Mathematical 18 ] & \\ {S}_{scf} = {c}_{0} {\sum }_{{n}^{′} = 1}^{{N}^{′}} {\{ {p}_{cf} ( {θ}_{cf} ( 1 - \frac{{n}^{′}}{{N}^{′}} ) ) ( cos ( {θ}_{cf} ( 1 - \frac{{n}^{′}}{{N}^{′}} ) ) \}}^{c 1} \{ {( \frac{{n}^{′}}{{N}^{′}} {j}_{scf} )}^{c 2} - {( \frac{{n}^{′} - 1}{{N}^{′}} {j}_{scf} )}^{c 2} \} & ( 18 )\end{matrix}$$

$$\begin{matrix}[ Mathematical 19 ] & \\ {S}_{acr} = {S}_{acf} + {c}_{0} {\sum }_{m = 1}^{M} {\{ {p}_{c} ( \frac{{mD}_{c}}{M} ) \}}^{{c}_{1}} \{ {( \frac{m}{M} {j}_{scr} )}^{{c}_{2}} - {( \frac{m - 1}{M} {j}_{scr} )}^{{c}_{2}} \} & ( 19 )\end{matrix}$$

In Equations (18) and (19), c0, c1, and c2 are soil parameters; pcf is a ground contact pressure of the idler 14 section of the crawler 18; θcf is an incident angle of the idler 14; N′ is the number of division of the incident angle θcf of the idler 14; M is the number of division of the length Dc of the crawler 18; n′ and m are variables for computation of summation; jscf is a slip amount related to an idling of the crawler 18 underneath the idler 14 in the xg-axis direction; and jscr is a slip amount related to an idling of the crawler 18 underneath the sprocket 16 in the xg-axis direction. The dynamic sinkages Sscf and Sscr at the time step tn computed in Step S28 are used when computing the normal stress distribution pc (Xc) underneath each crawler 18 at the time step tn+1 in Step S25.

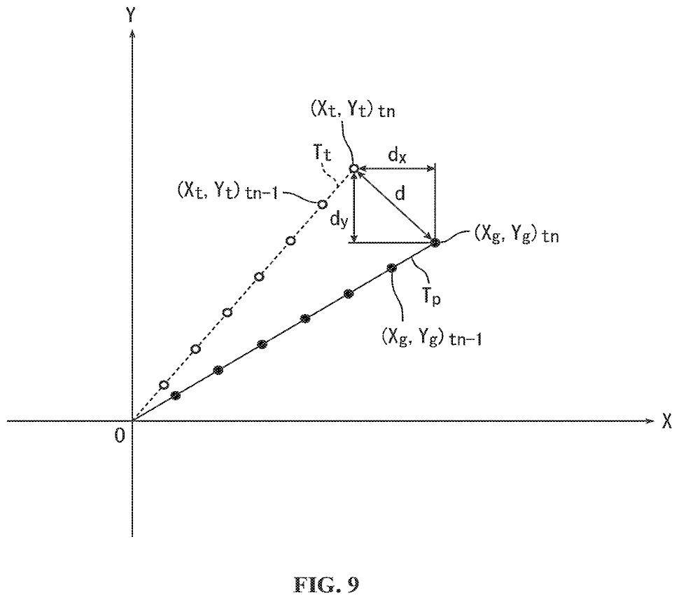

By repeating Steps S21 to S28 as described above, coordinates of the center of gravity G of the hydraulic shovel 2 at a plurality of time steps are computed, in the reference coordinate system (XY coordinate system), and a predicted trajectory TP (see FIG. 9) connecting the coordinates of the center of gravity G at each time step is obtained. Then, in the reference coordinate system (XY coordinate system), a deviation d between the coordinates (xg, yg) of the center of gravity G of the hydraulic shovel 2 at each time step in the predicted trajectory TP and the coordinates (xt, yt) of the center of gravity G of the hydraulic shovel 2 at each time step in a target trajectory TT (see FIG. 9) set in Step S1 is computed as a predicted slide-down amount of the hydraulic shovel 2 (Step S29). Alternatively, an X-axis direction component dx and a Y-axis direction component dy (components in an inclination direction of the slope 50) of the above-described deviation d are computed and the Y-axis direction component dy of the deviation d may be used as the predicted slide-down amount. Further, the computed predicted slide-down amount d may be displayed on the monitor in the cab 22 for each time step, and the predicted trajectory TP and the target trajectory TT may be displayed on the monitor in superposed manner in the cab 22.

In the hydraulic shovel 2, as described above, the upper revolving structure 6 is freely revolvable with respect to the lower traveling structure 4, and the working arm device 8 is swingable with respect to the upper revolving structure 6. However, when the revolving angle of the upper revolving structure 6 or the swinging angle of the working arm device 8 changes, the center of gravity G position of the hydraulic shovel 2 changes, and when the center of gravity G position changes, the crawler loads W1 and W2 change. Further, the crawler loads W1 and W2 also change depending on the angle η of the slope 50 and the traveling direction of the vehicle (vehicle direction angle θs). Then, when the crawler loads W1 and W2 change, the sinkage of the crawlers 18 changes, and when the sinkage of the crawler 18 changes, the predicted slide-down amount d changes.

In the present embodiment, as described above, after computing the center of gravity G positions of the hydraulic shovel 2 at the plurality of time steps, the crawler loads W1 and W2 at each time step are computed using the center of gravity G position of the hydraulic shovel 2, the angle 11 of the slope 50 and the traveling direction of the hydraulic shovel 2 (vehicle direction angle θs), and then the sinkage of the crawler 18 at each time step is computed using the crawler loads W1 and W2 obtained from the computation. On the basis of the computed sinkage of the crawler 18, computation of the predicted slide-down amount d of the hydraulic shovel 2 at each time step is executed.

In other words, in the present embodiment, the center of gravity G position of the hydraulic shovel 2 at the plurality of time steps, the angle η of the slope 50 and the traveling direction of the hydraulic shovel 2 (vehicle direction angle θs) are used to compute the predicted slide-down amount d at the plurality of time steps. Therefore, according to the present embodiment, even if the center of gravity G position of the hydraulic shovel 2, the angle η of the slope 50, and the traveling direction of the hydraulic shovel 2 have changed during the travel of the hydraulic shovel 2, the predicted slide-down amount d can be computed accurately.

In the present embodiment, since the center of gravity G position of the hydraulic shovel 2 is computed at every moment, and the computed center of gravity G position is incorporated into the computation flow of Step S2, the predicted slide-down amount d can be computed more accurately than when the predicted slide-down amount is computed while fixing the center of gravity G position at constant.

In the present embodiment, after executing Step S2 by the predicted slide-down amount computation means 44, as illustrated in FIG. 3, it is determined by the determination means 46 using the predicted slide-down amount d whether or not the hydraulic shovel 2 is allowed to travel on the slope 50 on the basis of the target trajectory TT (Step S3).

In Step S3, for example, if the maximum predicted slide-down amount d is within a predetermined value, it can be determined that the hydraulic shovel 2 is allowed to travel on the slope 50 on the basis of the target trajectory TT; and if the maximum predicted slide-down amount d exceeds the predetermined value, it can be determined that the hydraulic shovel 2 is not allowed to travel on the slope 50 on the basis of the target trajectory TT. This allows the hydraulic shovel 2 of which center of gravity G position can change during travel to be prevented from overturning due to the slide-down when traveling on the slope 50, as well as allows the actual traveling trajectory of the hydraulic shovel 2 to be prevented from deviating from the target trajectory TT.

In Step S3, even if the maximum predicted slide-down amount d is within a predetermined value, it may be determined that the hydraulic shovel 2 is not allowed to travel on the slope 50 on the basis of the target trajectory TT, when a place not suitable for the travel of the hydraulic shovel 2 is included in the predicted trajectory TP. The determination result of the determination means 46 may be displayed on the monitor in the cab 22, for example. Further, if it is determined that the hydraulic shovel 2 is not allowed to travel, the controller 40 may output a warning signal to the monitor or the speaker in the cab 22, display a warning screen on the monitor, and emit a warning sound from the speaker.

Then, if it is determined that the hydraulic shovel 2 is allowed to travel in Step S3, the controller 40 causes the hydraulic shovel 2 to travel (along the predicted trajectory TP) on the basis of the target trajectory TT at the command velocity set in Step S24, as illustrated in FIG. 3 (Step S4). On the other hand, if it is determined the hydraulic shovel 2 is not allowed to travel in Step S3, then Steps S1 to S3 are repeated until allowance determination is issued in Step S3.

As described above, according to the present embodiment, the predicted slide-down amounts d at the plurality of time steps are computed, using the center of gravity G positions of the hydraulic shovel 2 at the plurality of time steps, the angle η of the slope 50, and the traveling direction (vehicle direction angle θs) of the hydraulic shovel 2 in the slope 50. Since it is determined by using the predicted slide-down amount whether or not the hydraulic shovel 2 is allowed to travel on the slope 50 on the basis of the target trajectory TT, it is possible to prevent the hydraulic shovel 2 from overturning, and it is possible to prevent the actual traveling trajectory of the hydraulic shovel 2 from deviating largely from the target trajectory TT, thereby ensuring the safe travel of the hydraulic shovel 2.

The Steps S1 to S3 may be executed at real time during working by the hydraulic shovel 2 using the controller 40 (vehicle-mounted controller) mounted on the hydraulic shovel 2, or may be executed before working by the hydraulic shovel 2 is started. Further, Steps S1 to S3 can also be executed using a computer other than the controller 40 mounted on the hydraulic shovel 2.

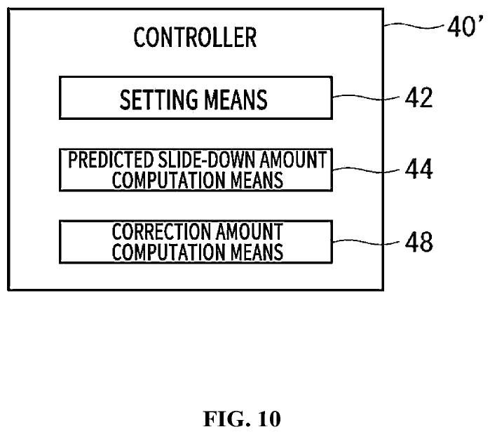

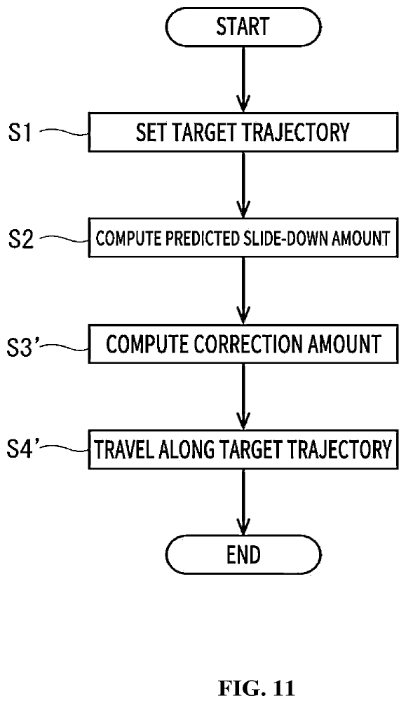

Next, other embodiments of the autonomous traveling control method for the crawler vehicle, the controller of the crawler vehicle, and the crawler vehicle of the present invention will be described with reference to FIGS. 10 and 11. In the following description, components that may be the same as the above-mentioned components are designated by the same reference numerals as those of the above-mentioned components, and therefore the description thereof will not be repeated.

To explain with reference to FIG. 10, the controller 40′, which controls the autonomous traveling of the hydraulic shovel 2, includes a correction amount computation means 48 for computing using the predicted slide-down amount d, a correction amount of the traveling direction (vehicle direction angle θs) for causing the hydraulic shovel 2 to travel along the target trajectory TT, in addition to the setting means 42 and the predicted slide-down amount computation means 44. Also in the controller 40′, similarly to the above-described controller 40, it may be composed of a computer having a processing device and a storage device, and various changeable data is stored therein, and information detected by various equipment is adapted to be input thereto.

In the present embodiment, as illustrated in FIG. 11, after executing Step S1 by the setting means 42, and Step S2 by the predicted slide-down amount computation means 44, Step S3′ for computing the correction amount of the traveling direction for causing the hydraulic shovel 2 to travel along the target trajectory TT using the predicted slide-down amount d, is executed by the correction amount computation means 48. In Step S3′ of the present embodiment, the correction amounts of the traveling directions of the hydraulic shovel 2 at the plurality of time steps are computed using the predicted slide-down amounts d at the plurality of time steps.

After executing Step S3′, the controller 40′ causes the hydraulic shovel 2 to travel along the target trajectory TT, by adjusting as necessary the command velocities of the left and right crawlers 18 at each time step which are set in Step S24, on the basis of the correction amounts of the traveling directions of the hydraulic shovel 2 at the plurality of time steps (Step S4′).

According to the present embodiment, the predicted slide-down amounts d at the plurality of time steps are computed using the center of gravity G position of the hydraulic shovel 2, the angle η of the slope 50 and the traveling direction (vehicle direction angle θs) of the hydraulic shovel 2 in the slope 50, and the correction amount of the traveling direction is computed using the predicted slide-down amount d at each time step, thereby enabling the hydraulic shovel 2 to travel along the target trajectory TT.

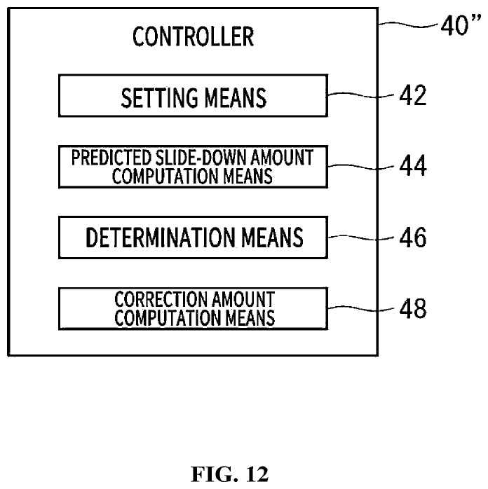

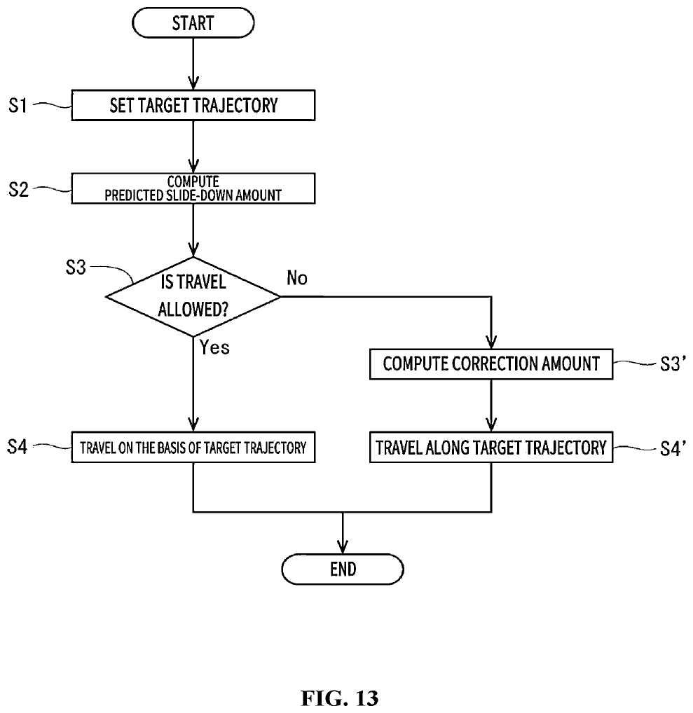

As illustrated in FIG. 12, the controller 40″ which controls the autonomous traveling of the hydraulic shovel 2 may comprise a setting means 42, a predicted slide-down amount computation means 44, a determination means 46, and a correction amount computation means 48. As illustrated in FIG. 13, when Step S1 is executed by the setting means 42, Step S2 is executed by the predicted slide-down amount computation means 44, and if it is determined by the determination means 46 that traveling is not allowed in Step S3, then Step S3′ for computing the correction amount of the traveling direction using the predicted slide-down amount d is executed by the correction amount computation means 48, and subsequently Step S4′ for causing the hydraulic shovel 2 to travel along the target trajectory TT may be executed.

1. An autonomous traveling control method for a crawler vehicle including the steps of:
setting a target trajectory of a crawler vehicle; and
computing a predicted slide-down amount of the crawler vehicle when the crawler vehicle travels on a slope on the basis of the target trajectory, using a center of gravity position of the crawler vehicle, an angle of the slope and a traveling direction of the crawler vehicle in the slope.

2. The autonomous traveling control method for the crawler vehicle according to claim 1, including a step of determining whether or not the crawler vehicle is allowed to travel on the slope on the basis of the target trajectory, using the predicted slide-down amount.

3. The autonomous traveling control method for the crawler vehicle according to claim 1, including a step of computing a correction amount of the traveling direction for causing the crawler vehicle to travel along the target trajectory, using the predicted slide-down amount.

4. The autonomous traveling control method for the crawler vehicle according to claim 1,
wherein the crawler vehicle comprises a lower traveling structure, an upper revolving structure supported by the lower traveling structure so as to be freely revolvable, and a working arm device mounted on the upper revolving structure so as to be freely swingable,
wherein in the step of computing the predicted slide-down amount, the center of gravity positions at a plurality of time steps are computed using a revolving angle of the upper revolving structure with respect to the lower traveling structure, and a swinging angle of the working arm device with respect to the upper revolving structure.

5. A controller of a crawler vehicle including:
a setting means for setting a target trajectory of a crawler vehicle; and
a predicted slide-down amount computation means for computing a predicted slide-down amount of the crawler vehicle when the crawler vehicle travels on a slope on the basis of the target trajectory, using a center of gravity position of the crawler vehicle, an angle of the slope and a traveling direction of the crawler vehicle in the slope.

6. The controller of the crawler vehicle according to claim 5, including a determination means for determining whether or not the crawler vehicle is allowed to travel on the slope on the basis of the target trajectory, using the predicted slide-down amount.

7. The controller of the crawler vehicle according to claim 5, including a correction amount computation means for computing a correction amount of the traveling direction for causing the crawler vehicle to travel along the target trajectory, using the predicted slide-down amount.

8. The controller of the crawler vehicle according to claim 5,
wherein the crawler vehicle comprises a lower traveling structure, an upper revolving structure supported by the lower traveling structure so as to be freely revolvable, and a working arm device mounted on the upper revolving structure so as to be freely swingable,
wherein the predicted slide-down amount computation means computes the center of gravity positions at a plurality of time steps, using a revolving angle of the upper revolving structure with respect to the lower traveling structure, and a swinging angle of the working arm device with respect to the upper revolving structure.

9. A crawler vehicle comprising the controller according to claim 5.
